(19) United States
(12) Patent Application Publication
(10) Pub. No.: US 2009/0263303 A1
(43) Pub. Date: Oct. 22, 2009

(54) Purification Device and Method for Purifying a Fluid Stream

(75) Inventors: Mark D. Fokema, Northborough, MA (US); Neng Ye, Boxborough, MA (US); Timothy Morin, Somerville, MA (US)

Correspondence Address: MODERN TIMES LEGAL, ONE BROADWAY , 14TH FLOOR, CAMBRIDGE, MA, 02142, US

(73) Assignee: ASPEN PRODUCTS GROUP, INC., Marlborough, MA (US)

(21) Appl. No.: 12/252,489

(22) Filed: Oct. 16, 2008

Related U.S. Application Data
(60) Provisional application No. 60/980,417, filed on Oct. 16, 2007.

(51) Int. Cl. B01D 53/56; B01J 19/00; B29C 47/00; B01D 53/72

(52) U.S. Cl. 423/239.1; 422/211; 264/465; 423/245.3

(57) ABSTRACT

A fibrous catalytic filter can be used for treating a fluid stream containing particulate matter. The fluid stream is contacted with fibers comprising a catalytic composition. The particulate matter deposits on the fibers and undesirable species within the fluid stream are converted into more desirable species via the catalytic action of the fibers.

### RELATED APPLICATION

This application claims the benefit of U.S. Provisional Application No. 60/980,417, filed Oct. 16, 2007, the entire content of which is incorporated herein by reference.

### GOVERNMENT SUPPORT

The invention was supported, in whole or in part, by grant number IIP-0750259 from the National Science Foundation. The Government has certain rights in this invention.

### BACKGROUND

Particulate (or aerosol) filters are used to purify a variety of different fluid streams. The removal of dust from air streams, pathogens from air streams, soot from combustion streams and ash from combustion streams are common applications for particulate filters. Particulates can be collected by a filter material via a variety of collection mechanisms, some of which include 1) inertial impaction, in which the particle deviates from the air stream (due to particle inertia) and collides with a filter element, 2) interception, in which a particle, because of its size, collides with a filter element, 3) diffusion, in which random motion of the particle causes it to collide with a filter element, and 4) electrostatic attraction, in which an electrostatic force brings the particle in contact with a filter element.

Particulate filters generally comprise rigid or flexible porous structures. Some of the more common types of filters include 1) fibrous filters, in which particles are trapped by a highly porous structure of fibers [for example, high-efficiency particulate air (HEPA) filters], 2) fabric filters, in which filtration primarily occurs within a particulate “cake” that builds up on the surface of a woven or felted fabric (for example, bag filters), 3) porous membrane filters, in which an assemblage of filter particles produces a tortuous pathway for the filtration stream to pass through (for example, granular filters and many ceramic filters), and 4) porous membranes filters, in which small, well-defined and often regularly-arranged pores provide filtration capability.

Catalytic functionality has been incorporated into many of these different types of filtration systems by adding catalytic materials into the filter. The thus-produced “catalytic filter” not only removes particulates from the filtration stream, but also promotes the conversion of at least one less desirable species in the filtration stream into at least one more desirable species in the filtered stream. Catalytic filters have generally been produced by dispersing catalyst particles into the filter structure or coating conventional filter elements with catalytic materials. This approach yields a non-homogeneous catalytic filter, wherein a substantial portion of the filter structure is comprised of essentially inert material.

Examples of previous attempts to produce a catalytic filter device include those set forth in U.S. Pat. Nos. 4,220,633 and 4,309,386 wherein an improved filter for gas cleansing is produced by weaving, impregnating or pre-coating a material that catalyzes the reduction of nitrogen oxides into nitrogen into a fibrous fabric filter bag. U.S. Pat. No. 5,051,391 discloses a catalytic filter containing particles comprising TiO₂, V₂O₅, WO₃ and mixtures thereof suspended in a woven fabric comprising glass and TiO₂ fibers that can be used for denitrating and removing dust from combustion exhaust gas. U.S. Pat. No. 4,732,879 discloses a method for coating substantially non-porous fibers with a thin, porous layer of catalytically active material. U.S. Pat. Nos. 4,902,487, 4,929,581, and 5,884,474 disclose methods for the removal of particulate matter contained in exhaust gas from a diesel-fueled engine, comprising supporting catalytic species on a porous surface, said catalytic species being able to promote the oxidation of particulates trapped upon the porous surface. Emig et al. (SAE Paper 960138) disclose a material used for the removal of particulates from diesel engine exhaust, comprising supported catalytic species on a knitted fiber support. U.S. Pat. No. 6,534,021 discloses a filter body capable of removing particles from a gas flow, reducing nitrogen oxides and oxidizing hydrocarbons. U.S. Pat. No. 5,221,520 discloses a method for purifying an air stream containing particulate matter and pollutants such as ammonia and formaldehyde by passing it through an oxidation catalyst coated onto a filter material.

One advantage of such catalyst-containing filters is that two processes can be achieved in a single device. In the above instances, the processes are particulate removal and conversion of at least one contaminant into more benign species.

A limitation of previous approaches is that the specific catalytic activity, measured in molecules converted per unit time per unit mass of the catalytic filter, is generally lower than conventional catalytic system due to low specific catalytic filter surface area (i.e., square meter of catalyst per gram of filter) which arises from the low catalyst element to filter element mass ratio of the catalytic filter.

An additional limitation of previous approaches employing catalyst coatings is that when filter media are coated with catalyst, media porosity is decreased and pore dimensions are reduced, resulting in reduced particulate filtration capacity, increased resistance to fluid flow and greater pressure drop across the filter.

Yet another limitation of previous approaches employing catalyst-coated filters in applications in which particulates are converted into gaseous species through contact with the catalyst is that imperfect coverage of catalyst on the filter media will leave exposed inert filter surfaces upon which particulates will accumulate and not be catalytically converted into gaseous species.

A further limitation of previous approaches employing catalyst coated fibrous filter media is that the supported catalyst may react with the fiber at elevated temperature to produce a species with reduced catalytic activity.

An additional limitation of previous approaches employing catalyst coated fibrous filter media is that when fibrous media are coated with catalyst, the diameters of the fibers are increased, resulting in reduced filtration efficiency.

Still another limitation of previous approaches employing catalyst particles suspended in fibrous filters is that the particles may abrade fibers during filter use or filter cleaning. This is particularly problematic for ceramic catalysts suspended in polymer filters.

Yet another limitation of previous approaches employing catalyst particles suspended in fibrous filters is that catalyst particles, if not attached strongly enough to the filter fibers, may be lost during filter use or filter cleaning, resulting in a decrease in specific catalytic activity.

Removal of particulate matter from diesel engine exhaust is an application for the subject invention. A common method for removing particulates from diesel exhaust involves using a diesel particulate filter (DPF) to collect particulates from the exhaust stream. The most efficient DPFs are wall flow filters in which the exhaust stream is forced to pass through a porous ceramic or porous metal “wall” as it passes from the inlet of the filter to the outlet of the filter. Particulates may be trapped within the filter via a deep bed filtration mechanism or by filtration through a soot cake that builds up on the surface of the filter media.

High exhaust soot concentrations result in rapid accumulation of soot within the DPF and necessitate the need for frequent removal of the accumulated soot from the DPF. Because diesel exhaust temperatures (typically 150-350° C.) are often not high enough to oxidize the organic particulates, the DPF can be periodically regenerated by heating the filter or exhaust stream to a temperature sufficient to initiate reaction of the collected organic particulates with gaseous oxidants present in the exhaust stream.

Because elaborate mechanisms are often required to initiate and control the DPF regeneration process and because the high temperature regeneration process can impose undesired stresses on the DPF, alternative approaches to avoid particulate matter accumulation in DPFs have been developed.

One approach employs a fuel-borne catalyst to catalytically reduce the particulate oxidation temperature. The fuel-borne catalyst, often containing platinum, cerium, manganese or iron, is contained in a fluid that is blended with the fuel prior to combustion and gets incorporated into the particulates which collect in the DPF. The particulates oxidize at a lower temperature than those produced without a fuel-borne catalyst, due to the catalytic effect of the catalyst. The lower oxidation temperature allows much of the particulates to be passively oxidized under normal engine operating conditions without the need for an active regeneration cycles. However, a fuel-borne catalyst approach is complex, requiring an on-board fuel additive tank, on-board additive dosing system and an infrastructure to distribute the fuel-borne catalyst additive. Additionally, fuel-borne catalysts contribute to accelerated ash deposition with the DPF, leading to reduced particulate filtration capacity, increased DPF pressure drop and more frequent DPF replacement or off-board cleaning.

To avoid the complexity of using a fuel-borne catalyst, catalyst-coated DPFs have been developed to promote particulate matter oxidation at reduced temperatures. The catalyst is coated onto the walls of the DPF to promote passive regeneration of organic particulates under normal operating conditions and to reduce the light-off temperature for the active regeneration process. A limitation to this approach is that catalyst-particulate contact is often poor, as the catalyst is contained in the coarse DPF wall while much of the particulate matter is filtered through a soot cake that builds up on the surface of the wall. Lack of catalyst-particulate contact adversely affects the ability to remove the entire loading of particulates.

Another approach to reducing particulate matter accumulation in DPFs employs NO₂ to continuously oxidize organic particulates that collect in the DPF. NO₂ is a stronger oxidizing agent than O₂ and oxidizes soot at temperatures above 250° C. Because most of the engine-out nitrogen oxides are in the form of NO, a Pt based catalyst (often containing 2-7 g Pt/ft³ catalyst volume) is commonly used to oxidize NO in the exhaust to NO₂ upstream of or within the DPF. This approach is only applicable to engines in which the exhaust temperature can be maintained above a certain temperature for a certain proportion of the engine operating period. Additional drawbacks to this approach include the high cost of the precious metal NO oxidation catalyst, the requirement to maintain minimum NOx/particulate ratio to ensure consistent particulate oxidation, and the ability of the precious metal catalyst to promote the formation of sulfates and thereby increase particulate emissions.

A variety of non-precious metal-based catalysts have been developed to promote the reaction of organic particulate matter with O₂, and/or NO₂. Uner et al. have demonstrated that CoOx-PbO reduces the peak combustion temperature of a mixture of soot and catalyst from 520° C. (uncatalyzed) to 343° C. in the presence of air. Van Setten et al. have proposed the use of eutectic mixtures of molten salts to reduce the oxidation temperature of soot. Olong et al. have demonstrated via combinatorial means that catalysts containing CsCl and CoOx are effective at reducing the temperature at which soot is oxidized by air. An et al. have demonstrated iron-based catalysts that reduce soot ignition temperatures in air to approximately 300° C. Liu et al. have reported a potassium-promoted vanadium oxide catalyst supported on titanium dioxide that initiates soot oxidation at 251° C. in the presence of NO and O₂.

Removal of particulate matter from cooking exhaust is another application for the subject invention. Particulates, primarily from fried or grilled foods, adversely affect indoor air quality and are a significant contributor to regional air pollution. Current precious-metal based flow through oxidation catalysts remove 80-90% of particulate emissions from charbroilers. Increased particulate removal efficiency and reduced costs are desired.

### SUMMARY

Described herein is a new catalytic filter that can be employed for the filtration of particulates from a fluid and catalytic reaction of constituents in the fluid as the fluid passes through the filter.

The new catalytic filter comprises a heterogeneous catalyst disposed in the form of porous fibers that can have diameters of less than 5 microns. In particular embodiments, the diameter of the fibers is less than 1 micron or even less than 200 nm. The small-diameter fibers provide the capability to filter particulates at high efficiency with a small filter thickness. The small diameter and high porosity of the fibers provides a large active surface area for the filtration stream to contact, thereby facilitating a high specific catalytic activity.

In one embodiment, an improved catalytic filtration system comprises a heterogeneous catalyst disposed in the form of porous fibers with a range of fiber diameters. Larger diameter catalytic fibers (greater than approximately 1 micron) provide mechanical strength and some filtering and catalytic functionality, while smaller diameter fibers (less than approximately 1 micron) provide the majority of the filtering and catalytic functionality.

In one embodiment, an improved catalytic filtration system comprises a heterogeneous catalyst disposed in the form of porous fibers (e.g., with diameters of less than 5 microns) and a supporting material that imparts improved mechanical properties to the filtration system. The supporting material does not provide a filtration or catalytic function.

In particular embodiments, the catalytic filter has a large amount of exposed catalytic surface area relative to the volume of the device; and mass transfer limitations associated with bulk fluid transport and pore diffusion are substantially reduced.

In a method for the production of the improved catalytic filtration material, a solution of catalyst fiber precursors is prepared in a suitable solvent and spun into fibers. The fibers are collected, dried and heated to produce porous fibers of the desired catalyst composition and phase.

In an alternative method for the production of the improved catalytic filtration material, a solution of catalyst fiber precursors is prepared in a suitable solvent and spun into fibers under the influence of an applied electric field. The fibers are collected, dried and heated to produce porous fibers of the desired catalyst composition and phase.

In an alternative method for the production of the improved catalytic filtration material, a solution of a portion of the catalyst fiber precursors is prepared in a suitable solvent and spun into fibers under the influence of an applied electric field. The fibers are then collected, dried and heated. The porous fibers are then impregnated with solutions containing the remaining catalyst precursors, such as metal nitrates, metal chlorides, metal carbonates, and the like. The impregnated fibers are then collected, dried and heated to produce fibers of the desired catalyst composition and phase.

The catalytic filters of this disclosure can offer improved filtration efficiency, reduced resistance to fluid flow, improved specific catalytic activity, reduced mass, reduced thermal mass, and improved durability, rendering them advantageous for use in advanced filtration systems, such as required for diesel exhaust and cooking exhaust clean up. In some embodiments, the temperature at which particulates are oxidized by the catalytic filter is substantially below the temperature of the stream containing the particulates, thereby solving the problem of particulate accumulation within the filter and avoiding the need for a repetitive filter cleaning process.

These and other advantages and attainments of the present invention will become apparent to those skilled in the art upon a reading of the following detailed description and illustrative embodiment of the invention.

### BRIEF DESCRIPTION OF THE DRAWINGS

In the course of the following detailed description, reference will be made to the attached drawings in which:

FIG. 1 is a representation of a previous catalytic filter;

FIG. 2 is a representation of a previous catalytic filter;

FIG. 3 is a representation of an embodiment of a catalytic filter of this disclosure;

FIG. 4 is a representation of a single fiber of the catalytic filter of FIG. 3;

FIG. 5 is a representation of a use of a catalytic filter of this disclosure;

FIG. 6 is a scanning electron micrograph image of catalytic fibers comprising ZrO₂ with an average diameter of 0.12 μm;

FIG. 7 is a scanning electron micrograph image of catalytic fibers comprising CeO₂ with an average diameter of 0.3 μm;

FIG. 8 is plot of median soot oxidation temperatures for different forms of TiO₂ and CeO₂ catalysts; and

FIG. 9 is a plot of the CO₂ produced during heating of a catalyst-soot mixture in air, wherein the catalyst is fibrous K_{0.5}La_{0.5}FeOₓ; and

FIG. 10 is a plot of the CO₂ produced during heating of the mixture of soot and fibrous K_{0.5}La_{0.5}FeOₓ in air and 500 ppm nitric oxide.

### DETAILED DESCRIPTION

Catalytic filters of this disclosure comprise porous fibers of a catalytic composition; the catalytic filters have proven effective for the simultaneous removal of particulates from a fluid and for the conversion of undesirable components within the fluid into more desirable components. The fibers of which the filters are composed can be micron- or sub-micron diameter fibers with surface areas sufficient to achieve appreciable catalytic reaction rates. Such an improved catalytic filter offers many advantages over previously known filters and catalysts.

An advantage provided by embodiments of the improved catalytic filter is that the proportion of catalyst contained in the catalytic filter is greater than that found in prior catalytic filters. The improved filter can consist of 100% catalytically active species, while prior catalytic filters are generally a blend of catalytic and inert components. The greater proportion of catalyst allows higher specific catalytic activities to be realized with the improved catalytic filter. This may result in reduced filter mass and reduced filter thermal mass.

Further, the fibers from which the filter is composed can be small in diameter and highly porous, allowing easy access of particulate species within the filtration fluid to active catalytic sites on the surface of the fibers while also allowing easy access of gaseous species within the filtration fluid to active catalytic sites on the surface of the fibers and within the fibers. The high specific catalytic surface areas facilitate high specific catalytic activities.

A further advantage that can be provided in the improved catalytic filter is high particulate collection efficiency. Particulate collection efficiency via impaction, interception and diffusion mechanisms increase as fiber radius decreases. Thus, at a fixed filter thickness and fiber packing fraction, the filter particulate collection efficiency is improved by reducing the diameter of the fibers from which the catalytic filter is formed. Similarly, equivalent filtration efficiency can be maintained while simultaneously reducing the filter fiber diameter and filter thickness, thereby reducing the volume and mass of fibers required to achieve a desired level of filtration.

An advantage of this catalytic filter relative to prior catalysts is that the reacting fluid can flow through the catalytic element rather than flowing over or around a catalyst or catalyst-coated support. For example, in a packed bed catalytic reactor, a reactant fluid flows through a packed bed of catalyst particles, with typical external dimensions from one millimeter to tens of millimeters, and both bulk and pore diffusion limitations can limit the reaction rate. For the catalytic filter, the reactant fluid flows through the pore structure of the filter, leaving only the length scale of the fiber diameter, preferably less than five microns, as a diffusion resistance. This flow configuration can greatly reduce bulk or pore diffusion limitations compared with the diffusion limitations present in more traditional catalytic reactors.

### Catalytic Filter:

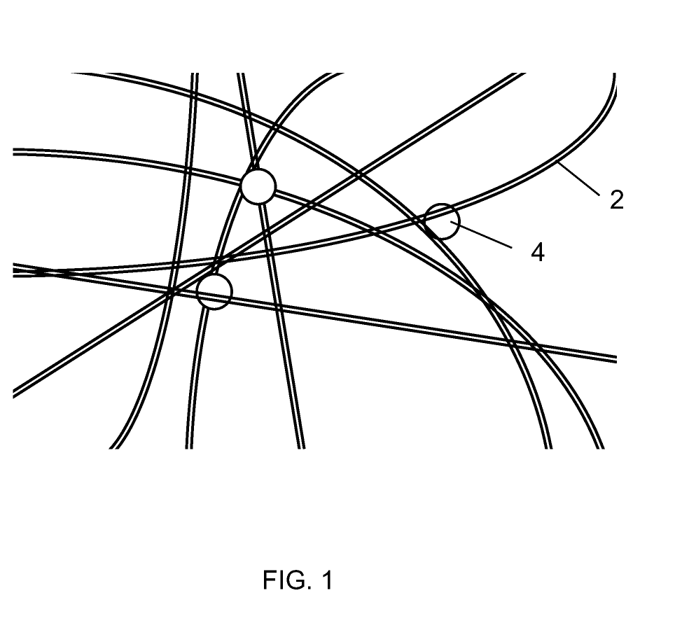

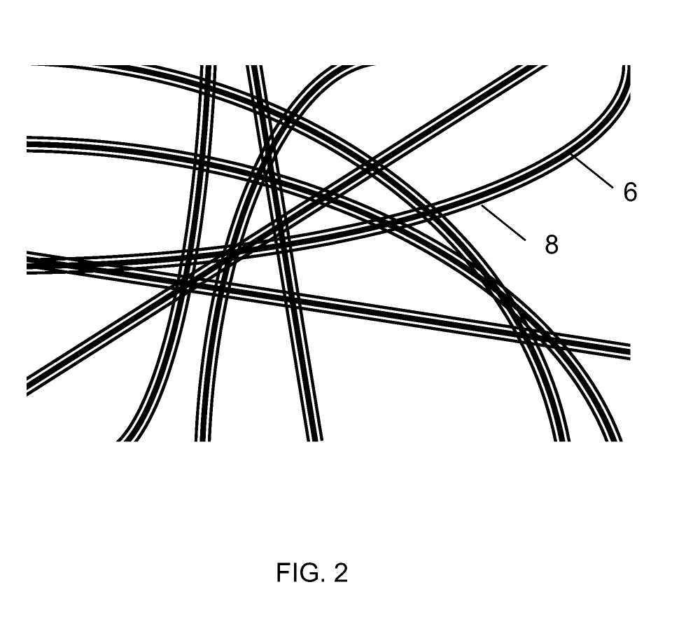

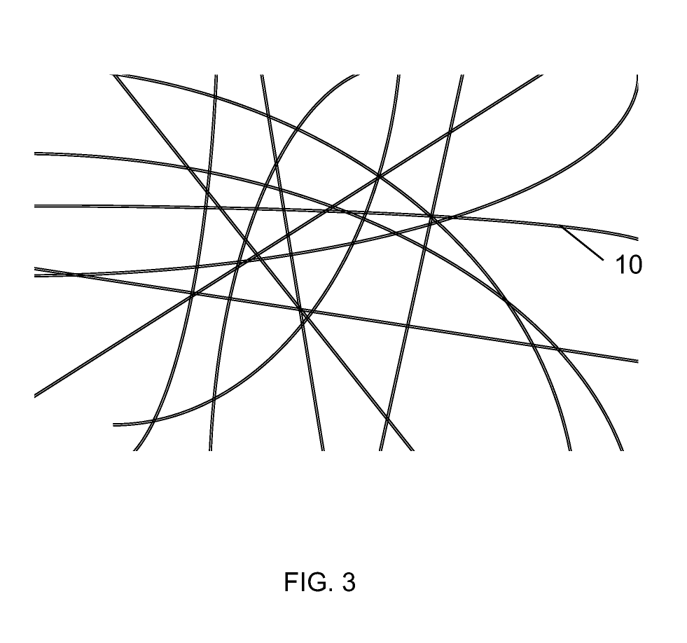

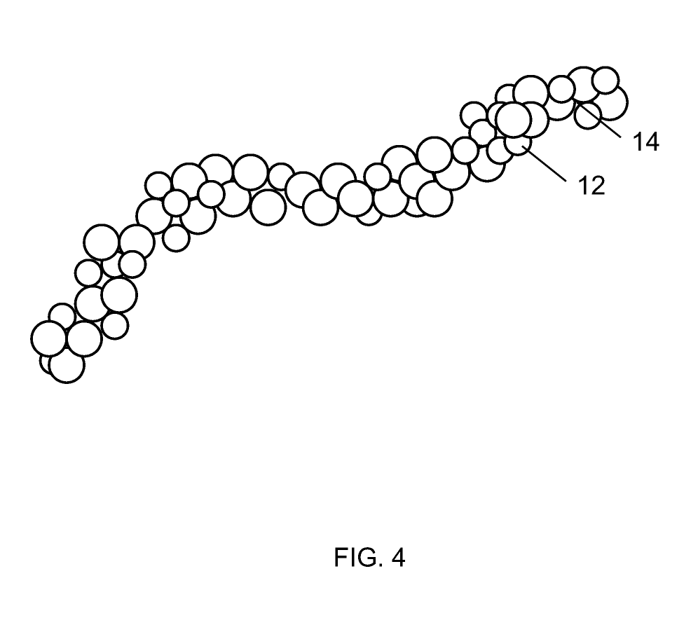

Referring to FIG. 1, a prior catalytic filter comprising catalyst particles 4 suspended in catalytically inactive fiber matrix 2 is shown. The catalyst particles often are held in place by electrostatic forces or are chemically bound to the filter fibers. FIG. 2 presents a prior catalytic filter comprising catalyst 8 coated onto catalytically inactive fiber matrix 6. The catalyst coating is often held in place by electrostatic forces or is chemically bound to the filter fibers. In contrast, an improved catalytic filter, shown in FIG. 3, consists of porous, catalytically active fibers 10 with diameters preferably averaging less than five microns. A detailed view of one fiber of the improved catalytic filter is presented in FIG. 4, wherein catalyst particles 12 of a substantially homogenous composition are bound together into a high-aspect-ratio construct that contains internal pores 14.

The internal porosity of the fibers is a feature that contributes significantly to the catalytic activity of the catalytic filter. For example, without internal porosity, 0.1 micron diameter dense CeO₂ fibers would exhibit a specific surface area of only 5 m²/g. A surface area of less than 1 m²/g would be realized with dense, 1 micron diameter, CeO₂ fibers. The improved catalytic filter can possess a specific surface area greater than 5 m²/g. In particular embodiments, the surface area of the catalytic filter is greater than 15 m²/g, greater than 25 m²/g, greater than 75 m²/g, greater than 150 m²/g, or even greater than 300 m²/g.

The catalytic filter can comprise a wide variety of catalytic materials, although formulations with a ceramic component are preferred in particular embodiments. Catalysts containing significant concentrations of Al₂O₃, SiO₂, TiO₂, ZrO₂, HfO₂, MgO, CaO, SrO, BaO, Li₂O, Na₂O, K₂O, Rb₂O, Cs₂O, Fe₂O₃, Mn₂O₃, V₂O₅, CuO, CoO, NiO, ZnO, Y₂O₃, MoO₃, WO₃, PbO, lanthanide oxides and mixtures and combined phases thereof (e.g, LaFeO₃) can be produced in a fibrous form that makes them suitable as catalytic filters.

Further, additional components can be dispersed upon the surfaces of the fibrous catalyst pores to improve catalytic activity. In an embodiment in which the catalyst comprises an active phase supported on a fibrous ceramic carrier, both the supported phase and carrier are able to independently catalyze the reaction of interest.

Because the fine fiber diameter imparts a high filtration efficiency to the catalytic filter, high filtration performance can be achieved with a very thin filter. The resulting reduction in overall filter volume is an additional advantage that the improved catalytic filter can provide over prior filters. The fine fiber diameter also imparts a large flow resistance to the catalytic filter. This large flow resistance most commonly manifests itself as a high trans-filter pressure drop per unit thickness of filter. To minimize pressure drop across the catalytic filter, the catalytic filter can be employed in the form of a thin filter assembly. For filters with equivalent filtration efficiency, a lower trans-filter pressure drop is generally realized with thinner filters composed of smaller diameter fibers compared to thicker filters composed of larger diameter fibers.

Although the strength of the catalytic filter was found to be sufficient for many filtration applications, the strength of thinner filter assemblies may be insufficient for some applications. In these instances, the fibers of the thin catalytic filter can be supported on a second porous layer that possesses greater strength characteristics than the thin fibrous catalytic filter media. The second porous layer can be in the form, e.g., of a ceramic honeycomb structure, a mesh or a pleated filter element. The combination of the fibers and the support structure will then have sufficient strength for an expanded array of applications.

In instances where the thin catalytic filter is supported on a second porous substrate, the second porous substrate can comprise a layer of catalyst fibers with a larger diameter than that of the first catalytic layer. In this embodiment, both layers provide filtration and catalytic functionality, and the filtration, catalytic and mechanical characteristics of the composite filter are improved over those realized by using either layer individually. A blending of the two catalyst fibers into a single filter layer, rather than a distinct layering of two materials comprised of different fiber diameters, may also be advantageous.

The catalytic filter or catalytic filter composite can be utilized in a variety of physical configurations. It can be arranged in a continuous-sheet structure, a corrugated-sheet structure, a hollow-fiber structure, a cellular “honeycomb-like” structure, and the like. Filtration can be achieved via a wall flow filter or flow through filter configuration.

### Formation of Catalytic Filters:

The catalytic filters of this disclosure can be prepared in various ways. One suitable method comprises physically spinning a solution that contains catalyst precursors into fibers. The solution can be prepared by dissolving metal alkoxides, metal salts and the like into a solvent, such as ethanol, propanol and the like. Subsequent addition of water and/or an acid or base catalyst, such as acetic acid or ammonia, respectively, promotes hydrolysis and condensation reactions of the catalyst precursors. While these reactions promote an increase in solution viscosity that assists in the fiber spinning process, additional polymer components, such as polyvinylpyrrolidone, polyethylene oxide, polyvinyl alcohol and the like, can also be blended into the solution to increase solution viscosity and facilitate spinning into fibers.

The spinning solution can also be prepared by dissolving metal salts and polymer components, such as polyvinylpyrrolidone, polyethylene oxide, polyvinyl alcohol and the like, into a solvent, such as water, ethanol, propanol and the like.

Spinning of the catalyst-precursor-containing solution into fibers can be conducted in a variety of ways. Extrusion of the viscous solution through a spinneret into a gas stream into which the solvent evaporates will yield multi-micron-sized fibers. Alternatively, the solution can be more slowly introduced into an electric field of approximately 0.5 to 5 kV/cm to produce sub-micron-sized fibers. A suitable apparatus for conducting this spinning process includes a syringe equipped with a conductive needle with an inner diameter of approximately 0.5 to 1 mm through which the solution is introduced and a conductive substrate spatially located at a defined distance from the needle tip upon which the spun fibers are collected. The needle and substrate may be moved relative to one another during the spinning process in order to produce large-area catalytic filter specimens. The substrate upon which the fibers are collected can be a reusable substrate from which the fibers are removed on a continuous or periodic basis. Alternatively, the substrate can include a supporting element that remains with the fibers in order to produce a composite catalytic filter with increased strength.

After spinning, the fibers are dried and heated to produce the desired catalytic phases within the fibrous structure. Removal of remaining solvent and water can be accomplished by placing the catalytic filter in a stream of flowing gas at ambient, depressed, or elevated temperature. The catalytic filter can then be treated in different oxidizing and reducing atmospheres at elevated temperatures in order to produce the active catalytic phases. For example, lanthanum (La) and iron (Fe) salts can be heated in air to produce lanthanum ferrite, LaFeO₃. Iron salts can be heated in air and then heated in hydrogen to produce ferrous oxide, FeO. In the case in which polymer is present in the spinning solution, the polymer can be oxidized or dissolved to remove the organic phase from the fiber, thereby producing additional porosity in the fiber. The fiber can exhibit a porosity of greater than 10%. In particular embodiments, the porosity of the fiber is greater than 20% or even greater than 30%.

The catalytic fibers can alternatively be produced by via a templating process. In this instance, catalyst precursors are deposited onto a nanofibrous or nanoporous substrate. Precursor deposition may occur through infiltration, adsorption from solution, condensation from a gaseous phase, and the like. Following thermal or microwave treatment to convert the precursors into the desired catalytic composition, the substrate is removed by chemical or thermal treatment. For example, if carbon nanofibers are used as a substrate, heat treatment in air can be used to oxidize the carbon and yield hollow catalytic nanofibers.

Incorporation of Additional Components into Filter:

If the catalytic filter produced from the solution-spinning process or templating process requires the incorporation of additional components in order to increase catalytic activity, these components can be introduced into the filter via impregnation. The impregnation can be carried out with multiple solutions containing different salts or other catalyst precursors, or with a single solution containing different salts or other catalyst precursors. The impregnation can be carried out by adding to the porous fibers enough solution to fill the pores, then drying and calcining. Alternatively, the impregnation can be carried out by soaking the porous fibers in an excess of solution from which the required amount of catalyst precursor is adsorbed by the fibers, after which the porous fibers are dried and calcined as before. Better results can be obtained by repeatedly impregnating the porous fibers with precursor solutions of lower concentrations followed by drying and calcining. By using solutions with low precursor concentrations, highly dispersed metal and metal oxide precursors are deposited on the porous carrier. Drying and calcining prior to the next impregnation step fixes the metal or metal oxide to the fibers and prevents redissolution of the precursor into the impregnating solution during the subsequent impregnation step. Repeated impregnation steps can also be conducted when it is desired to deposit larger amounts of the additional catalytic species onto the porous fibers. Catalyst precursor solutions can be formed in water, alcohol, or other suitable solvents.

Any soluble precursors of the catalytic formulation can be employed in promoting the catalysts. In particular embodiments, the precursors are selected from metal salts that can be decomposed to the metal by heating at a temperature below 800° C. or those that can be converted to the metal oxide by heating at a temperature below 800° C. Nitrates, chlorides, carbonates and the like are examples of suitable salts.

The porous fibers containing the solution of mixed precursors are dried by heating in air or in a stream of other suitable gas. The dried impregnated fibers are then heated to produce the desired active catalytic phase. The fibers can be heated in an oxidizing atmosphere, reducing atmosphere and/or inert atmosphere to different temperatures to retain the desired porous fiber characteristics and/or to produce the desired active catalytic phase. Parameters such as atmosphere, heating rate and duration of the heat treatment influence the properties of the final product.

### Use of the Catalytic Filter:

The catalytic fibers can be formed directly into filter elements, or coated onto porous supports, such as screens, meshes, papers, foams, and the like, in order to impart additional mechanical rigidity and strength. The catalytic fibers may be deposited directly onto the support surface during the fiber spinning process, or may be coated onto the support following fiber preparation and thermal treatment via conventional catalyst coating techniques or paper making techniques.

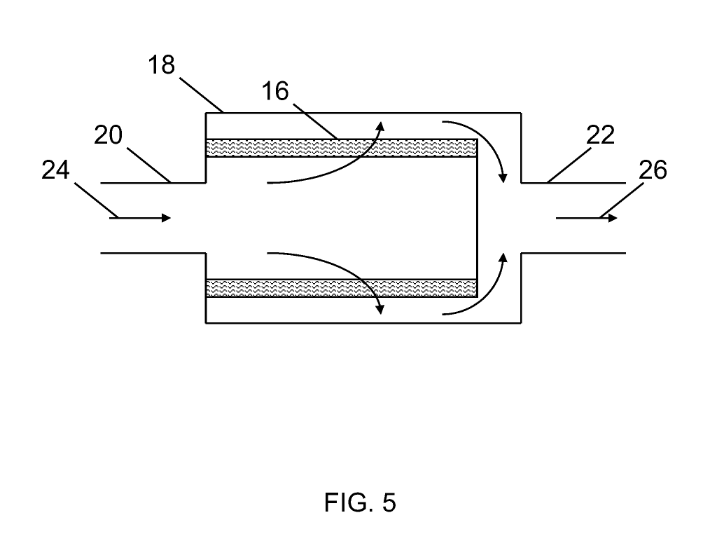

An embodiment of the use of the catalytic filter is presented in FIG. 5. The catalytic filter can be used in practice by placing the filter 16 into an enclosure 18 equipped with an inlet connection 20 and an outlet connection 22. The fluid stream to be filtered 24 is admitted to the enclosure via the enclosure inlet. Particulates are deposited on the catalytic filter, components react to form more desirable species and cleaned fluid 26 exits the system through the enclosure outlet. Depending on the level of filtration desired, the filter can be configured as a wall flow filter or a flow through filter. In a wall flow filter, the fluid must pass through the porous catalytic filter element in order to reach the filter outlet. In a flow through filter, the fluid passes over the surface of the porous catalytic filter element in order to reach the filter outlet. Only particulates passing close to the filter element surface are intercepted and collected in the flow through configuration. The wall flow configuration generally results in a greater filtration efficiency and greater pressure drop than the flow through configuration.

### Diesel Exhaust Filtration:

In an embodiment of the present invention, a catalyst exhibiting fibrous morphology is used to remove particulates from diesel exhaust while simultaneously oxidizing the particulates. The composition of the catalyst comprises Al₂O₃, SiO₂, TiO₂, ZrO₂, HfO₂, MgO, CaO, SrO, BaO, Li₂O, Na₂O, K₂O, Rb₂O, Cs₂O, Fe₂O₃, Mn₂O₃, V₂O₅, CuO, CoO, NiO, ZnO, Y₂O₃, MoO₃, WO₃, PbO, lanthanide oxides, and mixtures and combined phases thereof (e.g, LaFeO₃). The fibrous catalyst is comprised of fibers with an average diameter of less than 5 microns, more preferably less than 1 micron, and more preferably less than 200 nm.

When exposed to flowing air, the fibrous catalyst promotes the oxidation of collected organic particulate matter with oxygen at any of the following temperatures or less: 350° C., 300° C., 250° C., 200° C., 150° C., or 100° C. This enables continuous collection and oxidation of organic particulates at exhaust temperatures commonly encountered in many diesel engine applications. It was surprising that soot oxidation was observed at temperatures as low as 100° C., as temperatures of greater than approximately 350° C. are generally recognized as being required for non-catalyzed carbon oxidation.

Without wishing to be bound by any particular theory, it appears that the small catalyst fiber diameter provides numerous fiber external surface sites at which organic particulates may contact the catalyst. The external and internal porosity of the fibers can provide additional sites for activation of the gaseous oxidant. By increasing the contact of soot with the catalyst and increasing the rate of oxidant activation relative to that of conventional catalytic filter morphologies, the oxidation rate of the particulate is increased.

In addition to oxidizing the organic particulate matter, the fibrous catalyst can promote the oxidation of gaseous components, such as hydrocarbons and carbon monoxide.

A major advantage of this fibrous catalytic filter is that it continuously passively regenerates under normal load or driving conditions, regardless of the amount of NO and NO₂ present in the exhaust stream. Further, the fibrous catalytic filter includes no precious metal components, providing cost advantages over current DPF systems.

In another embodiment of the present invention, a fibrous catalyst is exposed to an exhaust stream containing particulates, oxygen and several hundred parts per million nitric oxide. The fibrous catalyst can promote the oxidation of collected organic particulate matter with oxygen and nitrogen oxides at any of the following temperatures or less: 350° C., 300° C., 250° C., 200° C., 150° C., or 100° C. These oxidation temperatures enable continuous collection and oxidation of organic particulates at exhaust temperatures commonly encountered in many diesel engine applications.

In addition to oxidizing the organic particulate matter, the fibrous catalyst can promote the oxidation of gaseous components, such as hydrocarbons and carbon monoxide.

A major advantage of this fibrous catalytic filter is that it continuously passively regenerates under normal load or driving conditions, regardless of the amount of NO and NO₂ present in the exhaust stream. While NO and NO₂ help lower the temperature at which the organic particulates oxidize, a significant fraction of the organic particulate oxidation is accomplished through the reaction of organic particulates with oxygen. Further, it includes no precious metal components, providing cost advantages over current DPF systems.

In another embodiment of the present invention, additional catalytic species are deposited onto the surface of the fibrous catalyst to further increase the organic particulate oxidation rate. Species such as vanadium oxide, lithium carbonate, sodium carbonate, potassium carbonate, rubidium carbonate and cesium carbonate have been found to enhance organic particulate oxidation.

Deposition of inorganic ash particulates, that originate from fuel components, lubrication oil and engine wear, within the catalytic filter may gradually impede the ability of organic particulates to reach the catalyst fiber surface, resulting in increased filter particulate loading, and increased transfilter pressure drop. In order to minimize the reduction in engine fuel economy that may thus occur with ash deposition, the catalytic filter may be operated at a progressively higher temperature to promote the oxidation of organic particulates that are not in direct contact with the catalyst fibers. The higher temperature may be achieved by direct heating of the filter, or modulating engine operation to increase exhaust temperature. The rate of ash deposition may also be reduced by implementing the catalytic fibers in a flow through filter rather than a wall flow filter. Replacement of the low-cost filter at a regular interval is another approach to minimizing the effect that ash deposition may have on engine performance.

The following examples illustrate formulations of the inventive catalytic filter and methods of synthesizing and using the catalytic filter.

### EXEMPLIFICATIONS

### Example 1

A solution suitable for spinning into a product from which fine TiO₂ fibers were derived was prepared by dissolving 3 ml acetic acid, 1.5 g titanium isopropoxide and 0.45 g polyvinylpyrrolidone (PVP, MW˜1300000) in 10.5 ml ethanol. After aging for one hour, the solution was loaded into a syringe equipped with a steel needle. The syringe was then loaded into a syringe pump, and the positive lead from a high-voltage power supply was connected to the needle. The negative lead from the high-voltage power supply was attached to a perforated steel sheet located 7.5 cm from the tip of the syringe needle. A potential of 7.5 kV was applied between the needle and the perforated steel sheet and the solution was ejected from the needle at a rate of 0.5 cm³ per hour.

After 1.5 cm³ of solution was spun, the syringe pump and power supply were turned off. The collected fibers were dried in place in air at ambient temperature for 16 hours and were then treated in flowing air at 450° C. for 5 hours. The resulting porous anatase TiO₂ fibers exhibited an average diameter of approximately 0.1 μm and possessed a surface area of 77 m²/g. Since a dense 0.1 μm TiO₂ fiber possess a geometric surface area of 10 m²/g, a majority of the produced TiO₂ fiber surface area resides within the fibers.

### Example 2

A solution suitable for spinning into a product from which fine TiO₂ fibers were derived was prepared by dissolving 3 ml acetic acid, 1 g titanium isopropoxide and 0.6 g PVP (MW˜1300000) in 10.5 ml ethanol. After aging for one hour, the solution was loaded into a syringe equipped with a steel needle. The syringe was then loaded into a syringe pump and the positive lead from a high-voltage power supply was connected to the needle. The negative lead from the high-voltage power supply was attached to a perforated steel sheet located 7.5 cm from the tip of the syringe needle. A potential of 10 kV was applied between the needle and the perforated steel sheet and the solution was ejected from the needle at a rate of 0.5 cm³ per hour.

After 3.5 cm³ of solution was spun, the syringe pump and power supply were turned off. The collected fibers were dried in place in air at ambient temperature for 16 hours and were then treated in flowing air at 450° C. for 5 hours to produce porous anatase TiO₂ fibers.

### Example 3

A solution suitable for spinning into a product from which fine ZrO₂ fibers were derived was prepared by dissolving 0.975 g ethylacetoacetate, 1.65 g zirconium n-propoxide, 0.6 g polyvinylpyrrolidone (MW˜1300000) in 7.5 ml ethanol and 4.9 g isopropanol. After aging for one hour, the solution was loaded into a syringe equipped with a steel needle. The syringe was then loaded into a syringe pump and the positive lead from a high-voltage power supply was connected to the needle. The negative lead from the high-voltage power supply was attached to a perforated steel sheet located 10 cm from the tip of the syringe needle. A potential of 12.5 kV was applied between the needle and the perforated steel sheet and the solution was ejected from the needle at a rate of 0.5 cm³ per hour.

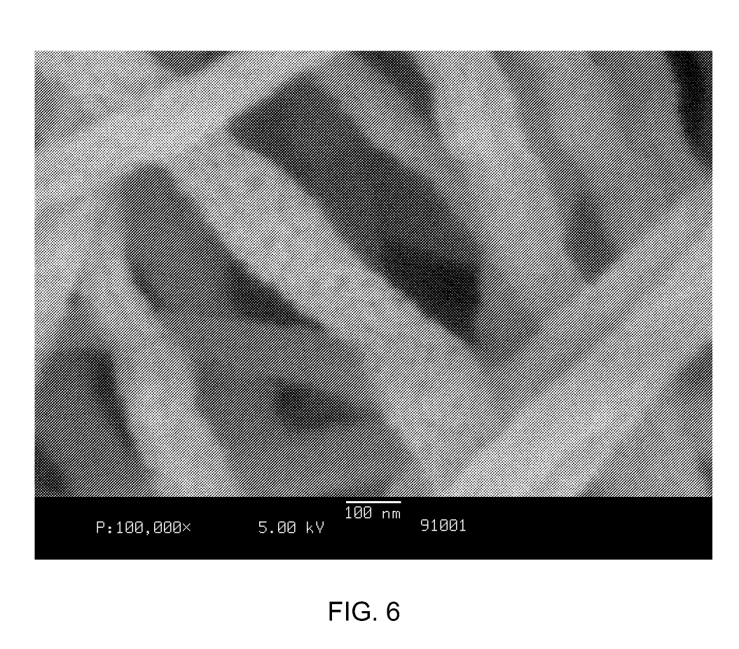

After 5 cm³ of solution was spun, the syringe pump and power supply were turned off. The collected fibers were dried in place in air at ambient temperature for 16 hours and were then treated in flowing air at 600° C. for 5 hours. The resulting porous ZrO₂ fibers exhibited an average diameter of approximately 0.12 μm and possessed a surface area of 35 m²/g. A micrograph of the porous ZrO₂ fibers is presented in FIG. 6.

### Example 4

The filtration characteristics of the filter of Example 2 were measured in a flow-through apparatus consisting of a nitrogen gas supply, acoustic aerosol generator, two one-inch-diameter filter housings and two differential pressure transducers. At gas flowrates ranging from 1 to 5 standard liters per minute (SLPM), the pressure drop across the filter was 9 to 35 inches of water. Measurements of filtration efficiency were made by aerosolizing a 0.4-to-12-μm-diameter spherical glassy carbon powder into 2 SLPM nitrogen and passing the aerosol sequentially through the filter and a backup HEPA filter. The weight gains of the two filters were used to assess filtration efficiency, which was calculated as the mass of powder deposited on the first filter divided by the mass of powder deposited on both filters. The filtration efficiency of the filter was 100%.

### Example 5

A solution suitable for spinning into a product from which fine CeO₂ fibers were derived was prepared by mixing a solution of 1.5 g ammonium cerium nitrate in 5 g H₂O with a solution of 0.88 g polyvinylpyrrolidone in 5 g ethanol. After stirring for 16 hours, the solution was loaded into a syringe equipped with a 14 gauge steel needle. The syringe was then loaded into a syringe pump, and the positive lead from a high-voltage power supply was connected to the needle. The negative lead from the high-voltage power supply was attached to an aluminum foil sheet located 12 cm from the tip of the syringe needle. A potential of 15 kV was applied between the needle and the foil, and the solution was ejected from the needle at a rate of 0.5 cm³ per hour.

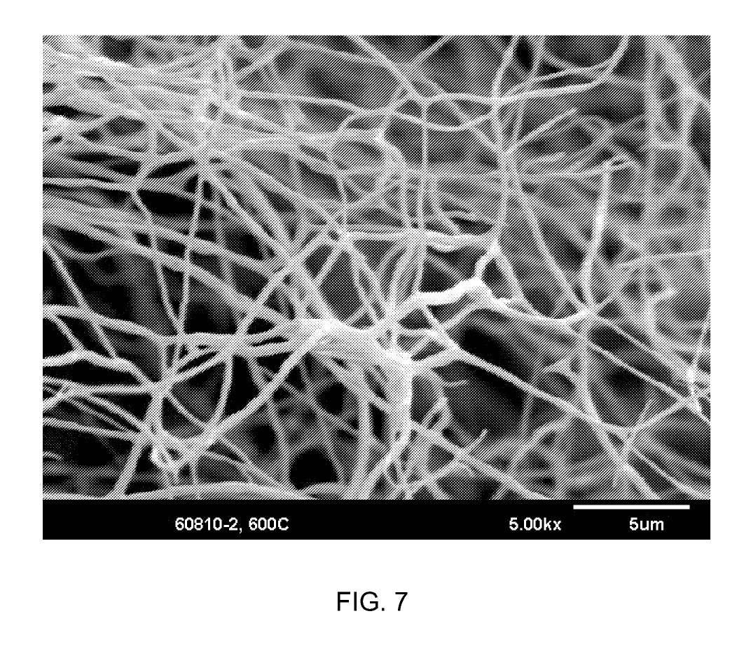

After 1.5 cm³ of solution was spun, the syringe pump and power supply were turned off. The collected fibers were dried in place in air at ambient temperature for 16 hours and were then treated in air at 600° C. for 5 hours. The resulting porous CeO₂ fibers exhibited an average diameter of approximately 0.3 μm. FIG. 7 presents a micrograph of the porous CeO₂ fibers.

### Example 6

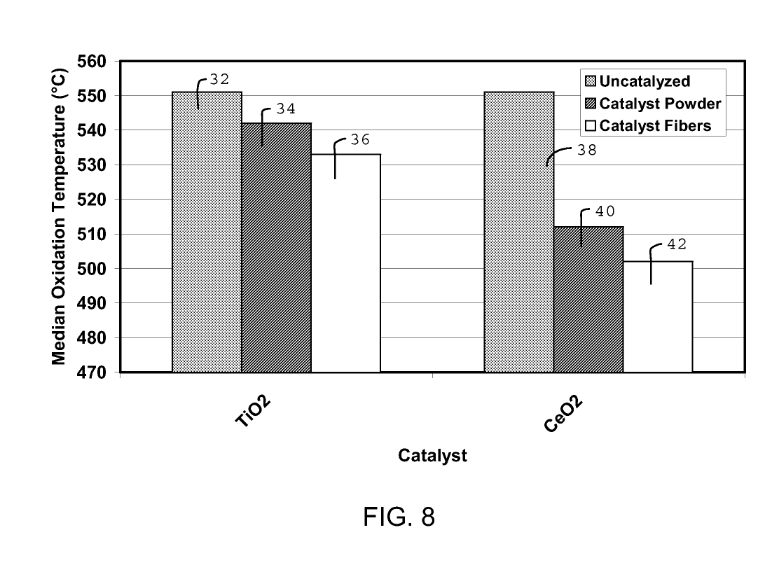

The soot oxidation activities of the nanofibers of Examples 1 and 5 and conventional powder catalysts were measured via temperature programmed oxidation of mixtures of 40 mg of catalysts with 4 mg Printex U soot [available from Evonik Industries (formerly Degussa) of Essen, Germany]. The catalysts and soot were blended by tumbling the powders in a small vial for 30 minutes. The catalyst-soot mixtures were heated from 25 to 750° C. at a rate of 2.5° C./min while 100 cm³/min air was passed through the mixtures. The CO and CO₂ concentrations in the exhaust gas were used to calculate the rate of soot oxidation. TiO₂ and CeO₂ lowered the temperature required to oxidize half of the soot in the sample from that observed for uncatalyzed soot oxidation (FIG. 8), as evidenced by the respective median oxidation temperatures for no catalyst 32, TiO₂ catalyst powder 34, and TiO₂ catalyst fibers 36, and for no catalyst 38, CeO₂ catalyst powder 40, and CeO₂ catalyst fibers 42. The nanofibrous catalysts promoted soot oxidation better than the powdered catalysts.

### Example 7

A solution suitable for spinning into a product from which fine K_{0.5}La_{0.5}FeOₓ fibers were derived was prepared by mixing a solution of 3.0 g iron nitrate nonahydrate, 0.375 g potassium nitrate, and 1.608 g lanthanum nitrate hexahydrate in 13.73 g water with a solution of 1.784 g polyvinylpyrrolidone in 13.73 g ethanol. After stirring for 16 hours, the solution was loaded into a syringe equipped with a 14 gauge steel needle. The syringe was then loaded into a syringe pump and the positive lead from a high-voltage power supply was connected to the needle. The negative lead from the high-voltage power supply was attached to an aluminum foil sheet located 12 cm from the tip of the syringe needle. A potential of 15 kV was applied between the needle and the foil, and the solution was ejected from the needle at a rate of 0.5 cm³ per hour.

After 8 cm³ of solution was spun, the syringe pump and power supply were turned off. The collected fibers were dried in place in air at ambient temperature for 16 hours and were then treated in air at 600° C. for 3 hours.

### Example 8

A solution suitable for spinning into a product from which fine Cs_{0.3}Cu_{0.4}Co_{0.3}Oₓ fibers were derived was prepared by mixing a solution of 1.13 g cesium nitrate, 1.80 g copper hemipentahydrate, and 1.69 g cobalt nitrate hexahydrate in 18.68 g water with a solution of 2.43 g polyvinylpyrrolidone in 18.68 g ethanol. After stirring for 6 hours, the solution was loaded into a syringe equipped with a 14 gauge steel needle. The syringe was then loaded into a syringe pump and the positive lead from a high-voltage power supply was connected to the needle. The negative lead from the high-voltage power supply was attached to an aluminum foil sheet located 12 cm from the tip of the syringe needle. A potential of 15 kV was applied between the needle and the foil, and the solution was ejected from the needle at a rate of 0.5 cm³ per hour.

After 8 cm³ of solution was spun, the syringe pump and power supply were turned off. The collected fibers were dried in place in air at ambient temperature for 16 hours and were then treated in air at 600° C. for 3 hours.

### Comparative Example 9

A sample of 1% Pt on Al₂O₃ particulate catalyst with a surface area of 300 m²/g was acquired from Alfa Aesar (Ward Hill, Mass.). The catalyst was treated in air at 500° C. for 3 hours.

### Example 10

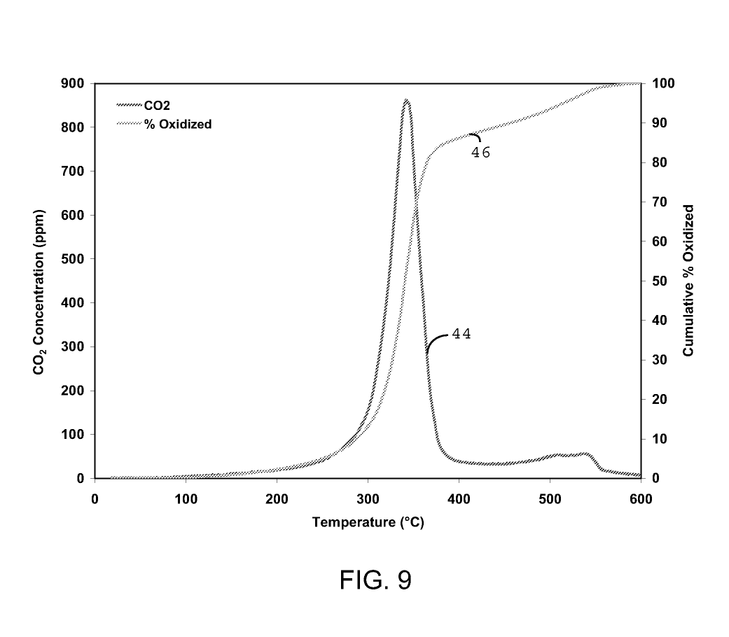

The soot oxidation activities of the fibrous catalyst of Example 7, the fibrous catalyst of Example 8, and the comparative particulate catalyst of Example 9 were measured via temperature-programmed oxidation of catalyst-soot mixtures. Each mixture was blended by lightly grinding 40 mg of catalyst with 2 mg Printex U soot in a mortar and pestle for 2 minutes. Each catalyst-soot mixture was heated from 25 to 600° C. at a rate of 2.5° C./min while 200 cm³/min air was passed through it. The CO₂ concentration (shown by plot 44 in FIG. 9) in the exhaust gas was used to calculate the rate of soot oxidation. The soot oxidation initiation temperature for the fibrous catalyst of Example 7 was approximately 100° C., as seen in FIG. 9. As shown by the percent-oxidation plot 46, the temperatures at which 5% and 50% of the carbon originally present in the mixture were oxidized for each catalyst-soot mixture and for uncatalyzed soot are listed in Table 1.

TABLE 1

| Catalyst | T_{5%} (° C.) | T_{50%} (° C.) |
|---|---|---|
| Example 7 | 250 | 341 |
| Example 8 | 209 | 294 |
| Example 9 | 395 | 532 |
| no catalyst | 434 | 550 |

### Example 11

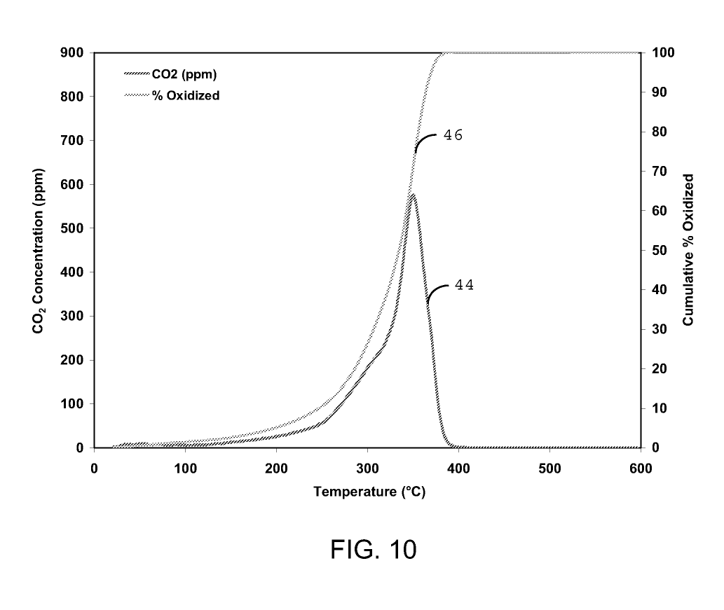

The soot oxidation activities of the fibrous catalyst of Example 7, the fibrous catalyst of Example 8, and the comparative particulate catalyst of Example 9 were measured via temperature-programmed oxidation of catalyst-soot mixtures. Each mixture was blended by lightly grinding 40 mg of catalyst with 2 mg Printex U soot in a mortar and pestle for 2 minutes. Each catalyst-soot mixture was heated from 25 to 600° C. at a rate of 2.5° C./min while 200 cm³/min air containing 500 ppm nitric oxide (NO) was passed through it. The CO₂ concentration (shown by plot 44 in FIG. 10) in the exhaust gas was used to calculate the rate of soot oxidation. The soot oxidation initiation temperature for the fibrous catalyst of Example 7 was approximately 100° C. (FIG. 10). As shown by the percent-oxidation plot 46, the temperatures at which 5% and 50% of the carbon originally present in the mixture were oxidized for each catalyst-soot mixture and for uncatalyzed soot are listed in Table 2.

TABLE 2

| Catalyst | T_{5%} (° C.) | T_{50%} (° C.) |
|---|---|---|
| Example 7 | 195 | 333 |
| Example 8 | 98 | 311 |
| Example 9 | 287 | 408 |
| no catalyst | 379 | 541 |

### Example 12

A solution was prepared by dissolving 7.1 mg of cesium carbonate in 0.40 g of distilled water. The solution was added to 40 mg of the fibrous catalyst of Example 7. The sample was dried in air at 120° C. for 2 hours and was then treated in air at 500° C. for 2 hours.

The soot oxidation activity of the fibrous catalyst impregnated with cesium carbonate was measured via temperature-programmed oxidation of the catalyst-soot mixture. The mixture was blended by lightly grinding 40 mg of catalyst with 2 mg Printex U soot in a mortar and pestle for 2 minutes. The catalyst-soot mixture was heated from 25 to 600° C. at a rate of 2.5° C./min while 200 cm³/min air was passed through it. The CO₂ concentration in the exhaust gas was used to calculate the rate of soot oxidation. The temperatures at which 5% and 50% of the carbon originally present in the mixture were oxidized were 114 and 306° C., respectively.

### Example 13

A solution suitable for spinning into a product from which fine K_{0.5}La_{0.5}FeOₓ fibers were derived was prepared by mixing a solution of 2.0 g iron nitrate nonahydrate, 0.25 g potassium nitrate, and 1.072 g lanthanum nitrate hexahydrate in 6.86 g water with a solution of 1.189 g polyvinylpyrrolidone in 6.86 g ethanol. After stirring for 16 hours, the solution was loaded into a syringe equipped with a 14 gauge steel needle. The syringe was then loaded into a syringe pump and the positive lead from a high-voltage power supply was connected to the needle. The negative lead from the high-voltage power supply was attached to an aluminum foil sheet located 12 cm from the tip of the syringe needle. A potential of 15 kV was applied between the needle and the foil, and the solution was ejected from the needle at a rate of 0.5 cm³ per hour.

After 1.5 cm³ of solution was spun, the syringe pump and power supply were turned off. The collected fibers were dried in place in air at ambient temperature for 16 hours and were then treated in air at 700° C. for 3 hours.

A solution was prepared by dissolving 32.1 mg of vanadium (IV) oxide bis[2,4-pentanedionate] in 2 mL of ethanol. 0.8 mL of this solution was added to 40 mg of the fibers in multiple stages to impregnate the fibers. The sample was dried in air at 60° C. for 30 minutes between additions of solution and then treated in air at 350° C. for 30 minutes after the final addition.

### Example 14

A quartz fiber filter washcoated with 20 wt % K_{0.5}La_{0.5}FeOₓ/CeO₂ nanofibers was secured into a flow-through filtration assembly, wherein inlet gas is forced to flow through the filter. The filter was heated to 400° C. in a stream of 10% O₂/90% N₂, and the outlet gas was monitored for CO and CO₂ using a non-dispersive infrared analyzer. An acoustic aerosol generator was used to periodically add an aerosol of Printex U soot to the 10% O₂/90% N₂ inlet gas. Prior to soot particle admission to the filter, CO and CO₂ concentrations in the exhaust gas were below 20 ppmᵥ. Within two minutes of turning on the aerosol generator, the CO₂ concentration increased to greater than 100 ppmᵥ, while the CO concentration increased to greater than 50 ppmᵥ. The CO₂ and CO concentrations decreased to their baseline values within six minutes of turning off the aerosol generator. No soot was observed in the outlet gas stream. The soot oxidation rate was calculated to be 0.04 mg/min when the aerosol generator was on.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/20^{th}, 1/10^{th}, ⅕^{th}, ⅓^{rd}, ½, etc., or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including patents and patent applications, cited throughout this application are hereby incorporated by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

What is claimed is:

1. A purification device, comprising:
a filter body defining a conduit for fluid flow; and
a porous body of catalytic fibers positioned in the conduit, wherein the catalytic fibers comprise a homogeneous metal oxide catalyst, and wherein the catalytic fibers have a mean diameter of less than 5 microns and a surface area greater than 15 m²/g.

2. The purification device of claim 1, wherein the porous body of catalytic fibers comprises catalytic fibers with a mean diameter of less than 1 micron.

3. The purification device of claim 1, wherein the porous body of catalytic fibers comprises catalytic fibers with a mean diameter of less than 0.2 micron.

4. The purification device of claim 1, wherein the porous body of catalytic fibers comprises catalytic fibers with a surface area greater than 75 m²/g.

5. The purification device of claim 1, wherein the catalytic fibers possess an average porosity of greater than 20%.

6. The purification device of claim 1, wherein the porous body of catalytic fibers comprises an oxide selected from Al₂O₃, SiO₂, TiO₂, ZrO₂, HfO₂, MgO, CaO, SrO, BaO, Li₂O, Na₂O, K₂O, Rb₂O, Cs₂O, Fe₂O₃, Mn₂O₃, V₂O₅, CuO, CoO, NiO, ZnO, Y₂O₃, MoO₃, WO₃, PbO, lanthanide oxides, and mixtures and combined phases thereof.

7. The purification device of claim 1, wherein the porous body of catalytic fibers comprises A_{w}BₓC_{y}O_{z}, wherein A is selected from Li, Na, K, Rb and Cs, B is selected from Sc, Y, La, Pr, Nd, Sm, Gd, Tb, Dy, Ho, Er, Tm, Yb and Lu, and C is selected from Cr, Mn, Fe, Co, Ni and Cu, and 0<w<1, 0<x<1, 0<y<1, w+x+y=2, and 1.5≦z≦3.

8. The purification device of claim 1, wherein the porous body of catalytic fibers comprises A_{w}BₓC_{y}O_{z}, wherein A is selected from Li, Na, K, Rb and Cs, B is selected from Cr, Mn, Fe, Co, Ni and Cu, and C is selected from Cr, Mn, Fe, Co, Ni and Cu, and 0<w<1, 0<x<1, 0<y<1, w+x+y=1, and 0.5≦z≦1.5.

9. The purification device of claim 1, wherein the porous body of catalytic fibers includes a coating of vanadium oxide at a loading equal to or less than 20 wt % of the porous body of catalytic fibers.

10. The purification device of claim 1, wherein the porous body of catalytic fibers includes a coating of Li₂CO₃, Na₂CO₃, K₂CO₃, Rb₂CO₃, Cs₂CO₃, or mixtures thereof, at a loading equal to or less than 20 wt % of the porous body of catalytic fibers.

11. The purification device of claim 1, wherein the porous body of catalytic fibers comprises catalytic fibers with a bimodal fiber diameter distribution with one mode above 1 micron and the other mode below 1 micron.

12. The purification device of claim 1, further comprising a support selected from a screen, mesh, paper, foam and monolithic substrate in the conduit, wherein the catalytic fibers are positioned against the support.

13. A method for purifying a fluid stream comprising:
passing a fluid through a porous body of catalytic fibers having a mean diameter of less than 5 microns;
trapping particulates within the fluid stream in the porous body of catalytic fibers; and
catalyzing the conversion of components within the fluid stream into other species.

14. The method of claim 13, wherein the conversion of components within the fluid stream into other species is catalyzed at 300-400° C.

15. The method of claim 13, wherein the conversion of components within the fluid stream into other species is catalyzed at 200-300° C.

16. The method of claim 13, wherein the conversion of components within the fluid stream into other species is catalyzed at 100-200° C.

17. The method of claim 13, wherein the conversion of components within the fluid stream into other species is catalyzed at 0-100° C.

18. The method of claim 13, wherein the fluid is an exhaust stream, wherein the trapped particulates include organic particulates, and wherein the organic particulates are catalytically converted into gaseous species via reaction with oxygen.

19. The method of claim 18, wherein the organic particulates are catalytically converted into gaseous species via reaction with oxygen and nitrogen oxides.

20. The method of claim 18, wherein the organic particulates, hydrocarbons and carbon monoxide within the exhaust stream are catalytically converted into carbon dioxide and water.

21. The method of claim 18, wherein the organic particulates, volatile organic compounds and carbon monoxide within the exhaust stream are catalytically converted into carbon dioxide and water.

22. The method of claim 13, wherein the catalytic fibers comprise a composition selected from an oxide selected from Al₂O₃, SiO₂, TiO₂, ZrO₂, HfO₂, MgO, CaO, SrO, BaO, Li₂O, Na₂O, K₂O, Rb₂O, Cs₂O, Fe₂O₃, Mn₂O₃, V₂O₅, CuO, CoO, NiO, ZnO, Y₂O₃, MoO₃, WO₃, PbO, lanthanide oxides, and mixtures and combined phases thereof.

23. The method of claim 13, wherein the catalytic fibers comprise A_{w}BₓC_{y}O_{z}, wherein A is selected from Li, Na, K, Rb and Cs, B is selected from Sc, Y, La, Pr, Nd, Sm, Gd, Tb, Dy, Ho, Er, Tm, Yb and Lu, and C is selected from Cr, Mn, Fe, Co, Ni and Cu, and 0<w<1, 0<x<1, 0<y≦1, w+x+y=2, and 1.5≦z≦3.

24. The method of claim 13, wherein the catalytic fibers comprise A_{w}BₓC_{y}O_{z}, wherein A is selected from Li, Na, K, Rb and Cs, B is selected from Cr, Mn, Fe, Co, Ni and Cu, and C is selected from Cr, Mn, Fe, Co, Ni and Cu, and 0<w<1, 0<x<1, 0≦y≦1, w+x+y=1, and 0.5≦z≦z≦1.5.

25. The method of claim 13, wherein the fluid is an exhaust stream, and the method further comprises passing the exhaust stream across an NO oxidation catalyst before passing through the porous body of catalytic fibers.

26. A method for fabricating a catalytic filter comprising:
dissolving metal salts and a polymer in a solvent to form a solution;
spinning the solution into fibers;
heating the fibers to produce a catalytic phase; and
supporting the fibers in a housing wherein the fibers can trap particulates from a flowing fluid.

27. A method of claim 26, further comprising applying an electric field of at least 0.5 kV/cm to the solution as it is spun into fibers.
